(19) United States
(12) Patent Application Publication
(10) Pub. No.: US 2016/0055174 A1
(43) Pub. Date: Feb. 25, 2016

(54) FACILITATING SEARCHING FOR GEOGRAPHIC PLACE NAMES

(71) Applicant: Adobe Systems Incorporated, San Jose, CA (US)

(72) Inventors: Kent A. Otis, Highland, UT (US); Jonathan D. Moon, Lehi, UT (US)

(21) Appl. No.: 14/463,292

(22) Filed: Aug. 19, 2014

(51) Int. Cl. G06F 17/30; G06F 17/28

(52) U.S. Cl. CPC G06F 17/30241; G06F 17/2863

(57) ABSTRACT

A data store of geographic place names includes geographic place names in each of multiple different languages for each of multiple different types of geographic places. These different types of geographic places can include cities, countries, regions (e.g., states), country codes, region (e.g., state) codes, and so forth. A user input is received that is a subset of characters in a geographic place name. A set of multiple geographic place names that match (e.g., are the same as) the user input is identified. This set of multiple geographic place names can include geographic place names of multiple different types of geographic places. The set of multiple geographic place names is presented to a user, allowing the user to select one or more of the presented geographic place names.

### BACKGROUND

As computing technology has advanced, the amount of data stored by computers has increased. While this accessibility to data is beneficial to users, it is not without its problems. One such problem is that it can be difficult for users to know what data is available for searching. Without knowing what data is available for searching, it is difficult for users to be able to make use of the access they have to data.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

In accordance with one or more aspects, an indication of a user input that is a subset of characters in a name of a geographic place is received. A data store of geographic place names of multiple different types of geographic places is accessed. The data store includes geographic place names in multiple different languages for each of multiple different geographic places of each of the multiple different types of geographic places. A set of multiple geographic place names that match the user input is identified from the data store, and an indication of the set of multiple geographic place names is provided for presentation to a user.

In accordance with one or more aspects, a user input that is a subset of characters in a name of a geographic place is received. A set of multiple geographic place names that match the user input is obtained from a data store of geographic place names of multiple different types of geographic places, and the set of multiple geographic place names is displayed. The data store includes geographic place names in multiple different languages for each of multiple different geographic places.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example system implementing the facilitating searching for geographic place names in accordance with one or more embodiments.

FIG. 2 is a flowchart illustrating an example process for generating a geographic place data store in accordance with one or more embodiments.

FIG. 3 is a flowchart illustrating an example process for presenting geographic place names for selection in accordance with one or more embodiments.

FIGS. 4, 5, 6, and 7 illustrate example user interfaces implementing the facilitating searching for geographic place names discussed herein.

FIG. 8 illustrates an example display for searching data using the facilitating searching for geographic place names discussed herein.

FIG. 9 illustrates an example system that includes an example computing device that is representative of one or more computing systems and/or devices that may implement the various techniques described herein.

### DETAILED DESCRIPTION

Facilitating searching for geographic place names is discussed herein. A data store of geographic place names is maintained. The data store includes geographic place names in each of multiple different languages for each of multiple different types of geographic places. These different types of geographic places can be, for example, cities, countries, regions (e.g., states), country codes, region (e.g., state) codes, and so forth. A user input is received that is a subset of characters in a geographic place name. A set of multiple geographic place names that match (e.g., are the same as) the user input is identified. This set of multiple geographic place names can include geographic place names of multiple different types of geographic places. The set of multiple geographic place names is presented to a user, allowing the user to select one or more of the presented geographic place names.

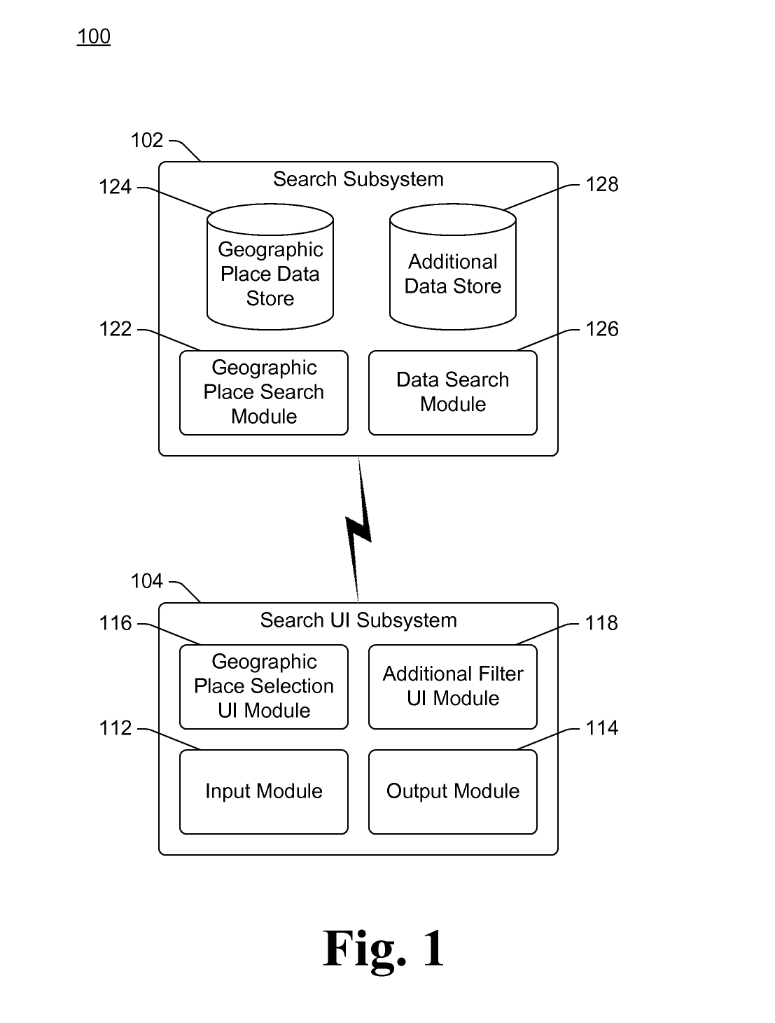

FIG. 1 illustrates an example system 100 implementing the facilitating searching for geographic place names in accordance with one or more embodiments. System 100 includes a search subsystem 102 and a search user interface (UI) subsystem 104. Subsystems 102 and 104 are illustrated as separate subsystems, but can alternatively be combined into a single subsystem, or alternatively separated into three or more subsystems. Search subsystem 102 receives search requests and searches various types of data. This data includes geographic places, and optionally additional types of data such as social media data. Search UI subsystem 104 provides a user interface allowing a user to input requests to search the various types of data and have the results of such searches presented to the user.

The system 100 is implemented on one or more computing devices. The system 100 can be implemented on a single computing device, or alternatively across multiple computing devices (e.g., the search subsystem 102 can be implemented on one computing device, and the search UI subsystem 104 can be implemented on another computing device). When system 100 is implemented across multiple computing devices, the multiple computing devices can communicate with one another using a variety of different networks such as the Internet, a local area network (LAN), a public telephone network, a wireless phone network, an intranet, other public and/or proprietary networks, combinations thereof, and so forth.

Each computing device used to implement at least part of the system 100 can be any of a variety of different types of computing devices. For example, the computing device can be a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth. When multiple computing devices are used to implement the system 100, the multiple computing devices can be the same or different types of computing devices.

The search UI subsystem includes an input module 112, an output module 114, a geographic place selection UI module 116, and an additional filter UI module 118. The input module 112 receives user inputs from a user of the search UI subsystem 104. User inputs can be provided in a variety of different manners, such as by pressing one or more keys of a keypad or keyboard of a computing device implementing the subsystem 104, pressing one or more keys of a controller (e.g., remote control device, mouse, trackpad, etc.) of the subsystem 104, pressing a particular portion of a touchpad or touchscreen of a computing device implementing the subsystem 104, making a particular gesture on a touchpad or touchscreen of a computing device implementing the subsystem 104, and/or making a particular gesture on a controller (e.g., remote control device, mouse, trackpad, etc.) of the subsystem 104. User inputs can also be provided via other physical feedback input to the subsystem 104, such as tapping any portion of a computing device implementing the subsystem 104, an action that can be recognized by a motion detection component of the subsystem 104 (such as shaking a computing device implementing the subsystem 104, rotating a computing device implementing the subsystem 104, etc.), and so forth. User inputs can also be provided in other manners, such as via audible inputs to a microphone, via motions of hands or other body parts observed by an image capture device, and so forth.

The output module 114 generates, manages, and/or outputs content for display, playback, and/or other presentation. This content can be created by the output module 114 or obtained from other modules of the search UI subsystem 104. This content can be, for example, a display or playback portion of a user interface (UI), such as display of a user interface generated by the geographic place search UI module or the additional filter UI module 118. The content can be displayed or otherwise played back by components of a computing device implementing the subsystem 104 (e.g., speakers, interactive display devices, etc.). Alternatively, the output module 114 can generate one or more signals that are output to other devices or components (e.g., speakers, display devices, etc.) that are separate from a computing device implementing the subsystem 104.

The geographic place search UI module 116 presents a user interface that allows the user to select a geographic place to be used for searching. Various different types of geographic places can be searched, such as cities, countries, regions (e.g., states), country codes, region (e.g., state) codes, and so forth. The UI module 116 presents a user interface allowing the user to input one or more characters in a name of a geographic place. The one or more characters are provided to the search system 102, which returns to the UI module 116 a set of one or more geographic place names that match the input one or more characters. These geographic place names are displayed or otherwise presented by the UI module 116, and a user input selecting one of the geographic place names is received. The selected geographic place name is the geographic place name desired by the user, and can be used for searching additional data.

The additional filter UI module 118 presents a user interface that allows the user to input various additional filters or criteria to search for additional data. The system 100 allows a user to search data based on various different filters or criteria, one of which is the geographic place associated with the data. Different types of data can be searched, such as social media data, as discussed in more detail below.

The search subsystem 102 includes a geographic place search module 122, a geographic place data store 124, a data search module 126, and an additional data store 128. The geographic place data store 124 stores names of geographic places. Names of various different types of geographic places can be stored, such as city names, country names, region (e.g., state) names, country codes, region (e.g., state) codes, and so forth. The data store 124 maintains each geographic name in multiple different languages, as discussed in more detail below.

The geographic place search module 122 receives indications of user inputs from the geographic place selection UI module 116. These user inputs are at least a subset of characters in a name of a geographic place desired by the user. The geographic place search module 122 accesses the geographic place data store 124 and identifies one or more geographic names that match the user input. These matching one or more geographic names are returned to the geographic place selection UI module 116 for presentation to the user.

The additional data store 128 stores additional data that can be searched by a user of the system 100. This additional data can take various different forms, such as social media data. Social media data refers to posts (public or private) made by users of various social networking or blogging (including microblogging) services, such as messages posted on a user's wall or space, tweets, and so forth. The data in the additional data store 128 has corresponding metadata describing various aspects of the data. These various aspects can include geographic places as well as other aspects, such as a date of the creation or publishing of the data, a time of the creation or publishing of the data, and so forth. Particular data in the additional data store 128 can be searched based on any of these various aspects (including geographic place), as well as based on the data itself (e.g., the data itself satisfying particular criteria).

The data search module 126 receives indications of additional filters or criteria to search for additional data from the additional filter UI module 118. The data search module 126 access the additional data store 128 and identifies data that satisfies the additional filters or criteria (as well as a selected geographic place as indicated by the geographic place selection UI module 116). This data that satisfies the additional filters or criteria are returned to the additional filter UI module 118 for output to the user. Additionally or alternatively, this data can be returned to another component or module for other processing (e.g., reporting, emailing, etc.).

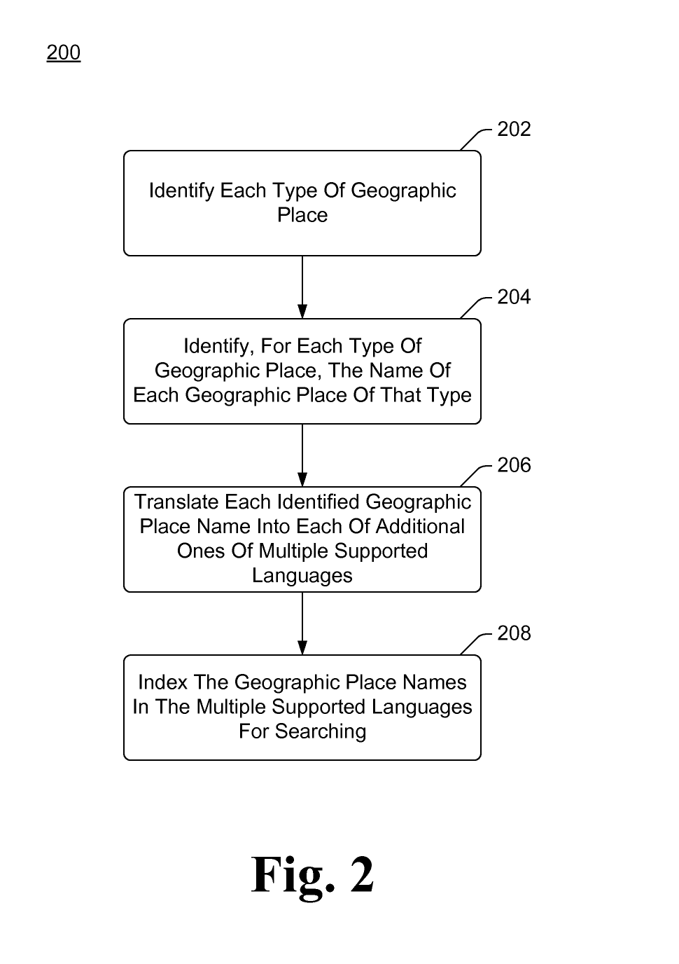

FIG. 2 is a flowchart illustrating an example process 200 for generating a geographic place data store in accordance with one or more embodiments. Process 200 is carried out by one or more computing devices, and can be implemented in software, firmware, hardware, or combinations thereof. Process 200 is shown as a set of acts and is not limited to the order shown for performing the operations of the various acts. Process 200 is an example process for generating a geographic place data store; additional discussions of generating a geographic place data store are included herein with reference to different figures.

In process 200, each type of geographic place is identified (act 202). Various different types of geographic places can be identified, such as cities, countries, regions (e.g., states, provinces, etc.), country codes, region (e.g., state, province, etc.) codes, and so forth. All of these types of geographic places can be identified in act 202, or alternatively one or more other types of geographic places can be identified. Alternatively, any subset of these different types of geographic places can be identified. For example, the types of geographic places that are identified in act 202 can be cities, countries, and regions.

The types of geographic places can be identified in act 202 in a variety of different manners. For example, the types of geographic places can be specified by a developer of the system 100 of FIG. 1, by a user of the system 100, by another component or system, and so forth.

For each type of geographic place identified in act 202, the name of each geographic place of that type is identified (act 204). The geographic place names that are supported by the system 100 are identified in act 204. Geographic place names supported by the system 100 refer to names of geographic places that can be presented to the user by the geographic place selection UI module 116. For example, for the city type of geographic place, the name of each city that is supported by the system 100 is identified in act 204. By way of another example, for the country type of geographic place, the name of each country that is supported by the system 100 is identified in act 204.

The geographic place names can be identified in a variety of different manners. For example, a database, listing, or other record of city names can be accessed, and each city name in that database, listing, or other record is identified as a geographic place name in act 204. By way of another example, a database, listing, or other record of country codes can be accessed, and each country code name in that database, listing, or other record is identified as a geographic place name in act 204.

Each geographic place name identified in act 204 is translated into each of additional ones of multiple supported languages (act 206). The system 100 supports multiple different languages, and each of the geographic place names identified in act 204 are in one of those languages. Those geographic place names are translated into each of the other supported languages in act 206. The translation in act 206 can be performed in various different manners, such as using automated translation tools or services, by various individuals, by accessing translation dictionaries or other records, and so forth.

The geographic place names in the multiple supported languages are indexed for searching (act 208). Indexing the geographic place names refers to analyzing, determining, and recording various information regarding the geographic place names to facilitate searching through the geographic place names and increase the speed at which the place names can be searched.

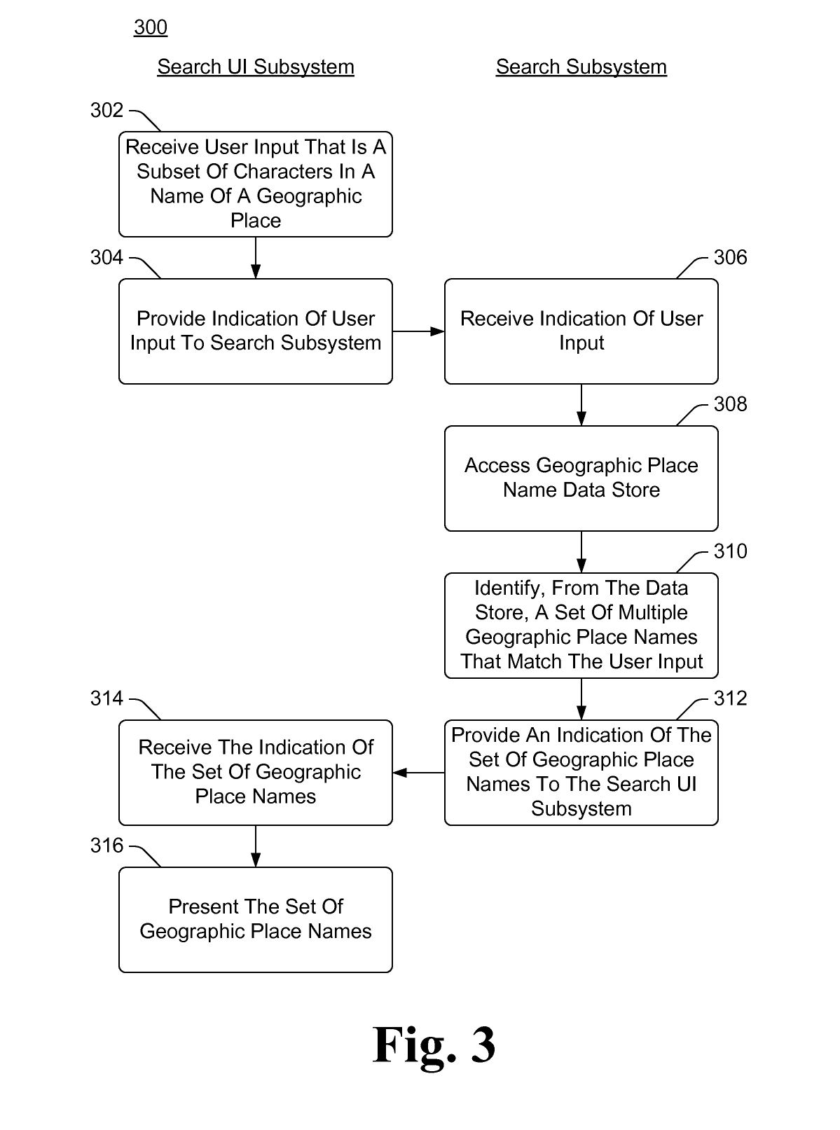

FIG. 3 is a flowchart illustrating an example process 300 for presenting geographic place names for selection in accordance with one or more embodiments. Process 300 can be implemented in software, firmware, hardware, or combinations thereof. Acts of process 300 illustrated on the left-hand side of FIG. 3 are carried out by a search UI subsystem, such as search UI subsystem 104 of FIG. 1. Acts of process 300 illustrated on the right-hand side of FIG. 3 are carried out by a search subsystem, such as search subsystem 102 of FIG. 1. Process 300 is shown as a set of acts and is not limited to the order shown for performing the operations of the various acts. Process 300 is an example process for presenting geographic place names for selection; additional discussions of presenting geographic place names for selection are included herein with reference to different figures.

In process 300, user input that is a subset of characters in a name of a geographic place is received (act 302). The user input can be received in any of a variety of different manners, as discussed above. The user input is displayed in a data entry field as the user input is received.

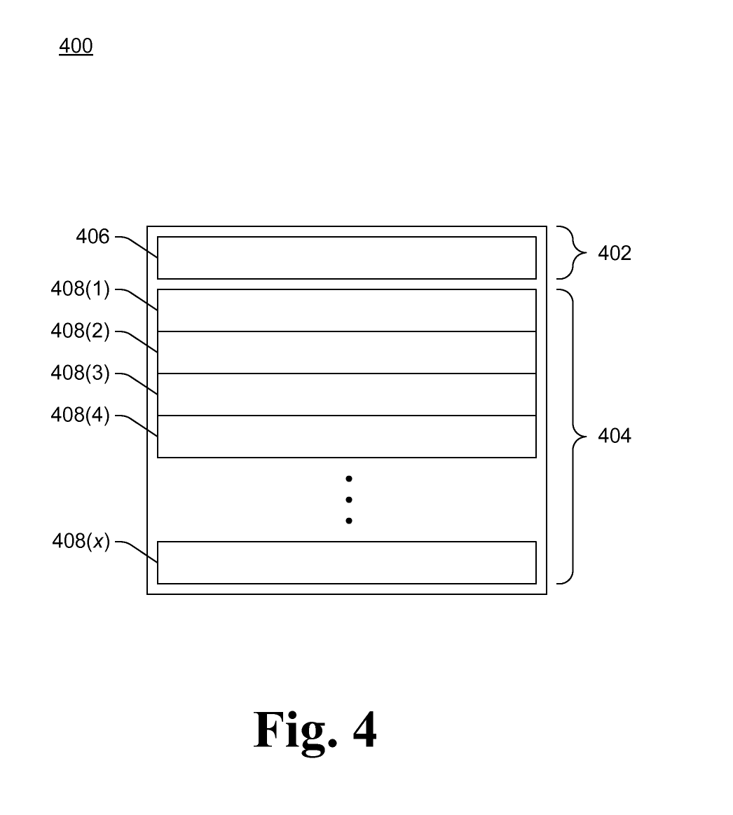

FIG. 4 illustrates an example user interface 400 implementing the facilitating searching for geographic place names discussed herein. The user interface 400 includes a data entry portion 402 and a geographic place name display portion 404. The data entry portion 402 includes a data entry field 406 in which the characters of the user input are displayed. The geographic place name display portion 404 includes multiple fields 408(1), . . . , 408(x) in each of which is displayed a geographic place name. As the user input is received, the user input is displayed in the data entry field 406.

Returning to FIG. 3, an indication of the user input is provided to the search subsystem (act 304). The indication of the user input is the subset of characters in the name received in act 302, or some other identifier of the subset of characters in the name received in act 302.

The indication of the user input is received by the search subsystem (act 306). The search subsystem accesses the geographic place name data store (act 308), and identifies from the store a set of multiple geographic place names that match the user input (act 310).

A geographic place name matches the user input if the geographic place name includes the same characters in the same locations of the geographic place name as the characters in the subset of characters. The characters can be entered in any of multiple different languages, and can include various different types of characters such as English letters, Cyrillic characters, Kanji characters, and so forth. In one or more embodiments the characters are not case sensitive (e.g., so the character “Y” is treated the same as the character “y”). By way of example, if the user input is the characters “spa”, then any geographic place name that begins with (has the first three characters of, and has the first three characters in the same order or locations as) the characters “spa” would match the user input. Various wildcard values can also be used, for example the symbol “?” can be used to represent any single character, the symbol “*” can be used to represent any number of (zero or more) characters, and so forth.

It should be noted that, for the identification of geographic place names that match the user input, the language of the geographic place name can be ignored. For example, if the user input is “las”, any geographic place name that begins with “las” regardless of the language of the geographic place name matches the user input. For example, geographic place names in English, Spanish, French, and so forth that begin with “las” would all match the user input “las”.

In one or more embodiments, the set of geographic place names that is identified in act 310 includes less than all of the geographic place names in the geographic place name data store that match the user input. Depending on the number of geographic place names in the geographic place name data store and the number of characters in the user input, a large number (e.g., tens, hundreds, or more) of geographic place names may match the user input. Accordingly, the search subsystem uses one or more rules or other criteria to determine which geographic place names that match the user input are included in the identified set of multiple geographic place names in act 310.

Various rules or criteria are used to determine which geographic place names that match the user input are included in the identified set of multiple geographic place names. For example, the rules or criteria may specify that certain types of geographic places are added to the set before other types of geographic places are added to the set (e.g., countries may be added to the set before cities are added to the set). By way of another example, the rules or criteria may specify that at least a threshold number (e.g., one or two) of geographic place names of each of multiple types of geographic places be added to the set (e.g., two country names, two region names, two city names, and so forth). By way of another example, the rules or criteria may specify that the geographic place names are added to the set in the order the geographic place names are identified as matching the user input (using whatever search algorithm or process the search subsystem uses) until a threshold number (e.g., seven, ten, twenty, and so forth) are added to the set. By way of yet another example, the rules or criteria may specify that the geographic place names that are included in the set are selected randomly or pseudo-randomly from the geographic place names that match the user input.

Regardless of how the set of multiple geographic place names is identified, the identified set of geographic place names is provided to the search UI subsystem (act 312). The indication of the set of geographic place names is the geographic place names in the set, or some other identifier of the geographic place names subset in the set. The search UI subsystem receives the indication of the set of geographic place names (act 314), and presents the set of geographic place names (act 316). Oftentimes the geographic place names are presented by being displayed, but the geographic place names can alternatively be presented in other manners (e.g., by being played back audibly).

In one or more embodiments, one of the presented geographic place names can be selected by the user. The selected geographic place name is the geographic place name desired by the user. A user can select one of the presented geographic place names in any of a variety of different manners using various different user inputs, as discussed above. For example, the user may select a geographic place name by clicking on one of the displayed geographic place names with a mouse and pointer, by touching the displayed geographic place name (in situations in which the user interface is displayed on a touchscreen), by navigating through the presented set of geographic place names using arrow keys of a keyboard and pressing an “enter” key when the desired geographic place name has been navigated to, and so forth.

Various rules or criteria are used to determine the order in which the geographic place names are presented in act 316. For example, the rules or criteria may specify that certain types of geographic places are presented before or above (e.g., in a list from top to bottom) other types of geographic places are presented (e.g., countries are to be presented above regions, regions are to be presented above cities, and so forth). By way of another example, the rules or criteria may specify that the geographic place names are presented in the order that the geographic place names are identified in the set. By way of yet another example, the rules or criteria may specify that the geographic place names in the set are presented in a random or pseudo-random order.

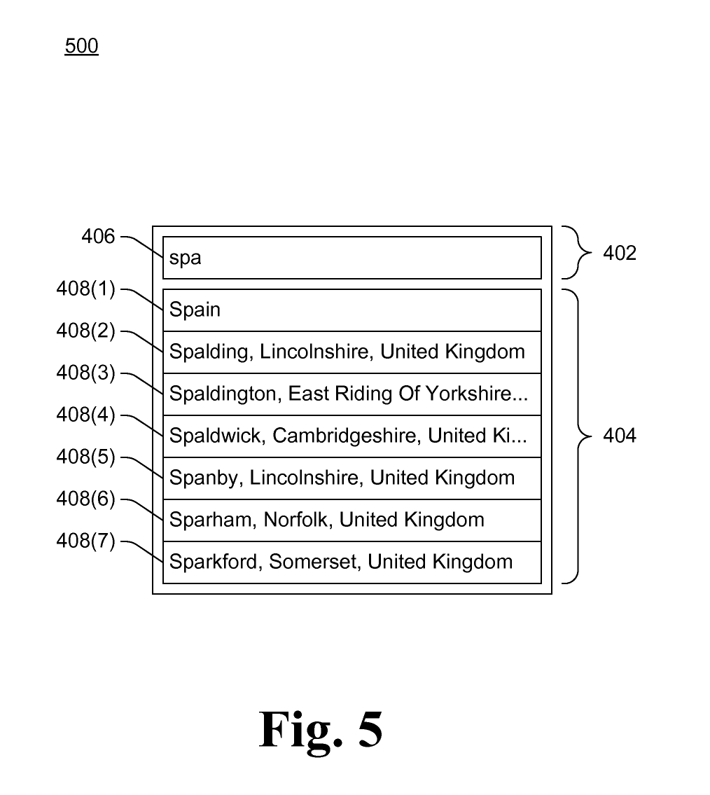

FIG. 5 illustrates an example user interface 500 implementing the facilitating searching for geographic place names discussed herein. The user interface 500 includes the data entry portion 402 with the data entry field 406, and the geographic place name display portion 404. In the illustrated example of FIG. 5, the user input is the characters “spa”, which is displayed in the data entry field 406. The set of geographic place names that match the user input “spa” are displayed in the geographic place name display portion 404 in fields 408(1), . . . , 408(7). As illustrated, seven different geographic place names that match the user input are displayed in the geographic place name display portion 404. A user can select one of the displayed geographic place names in the geographic place name display portion 404 in any of a variety of different manners, as discussed above regarding FIG. 3.

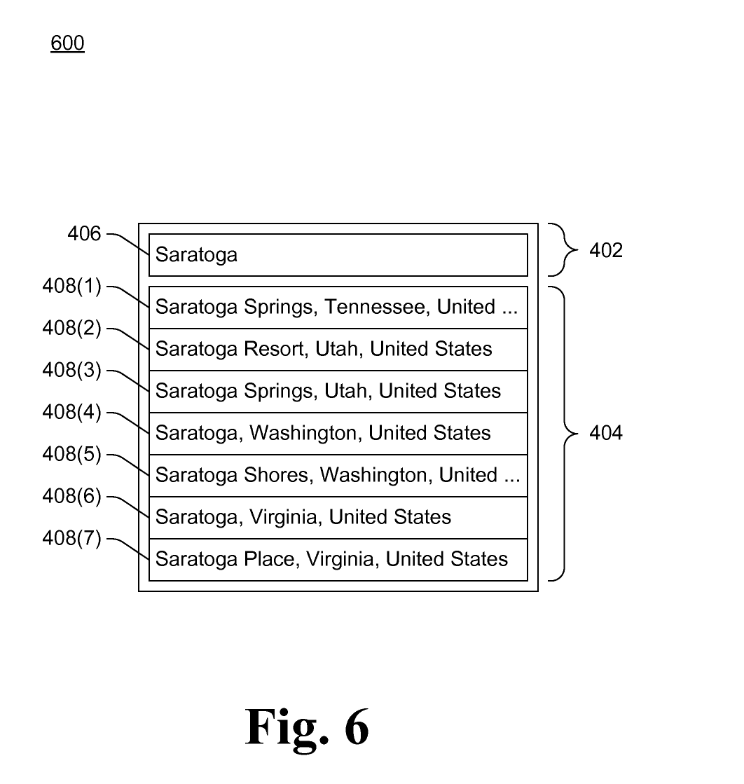

FIG. 6 illustrates another example user interface 600 implementing the facilitating searching for geographic place names discussed herein. The user interface 600 includes the data entry portion 402 with the data entry field 406, and the geographic place name display portion 404. In the illustrated example of FIG. 6, the user input is the characters “Saratoga”, which is displayed in the data entry field 406. The set of geographic place names that match the user input “Saratoga” are displayed in the geographic place name display portion 404 in fields 408(1), . . . , 408(7). As illustrated, seven different geographic place names that match the user input are displayed in the geographic place name display portion 404. A user can select one of the displayed geographic place names in the geographic place name display portion 404 in any of a variety of different manners, as discussed above regarding FIG. 3.

Returning to FIG. 3, in one or more embodiments the search UI subsystem is configured to present the set of geographic place names in a particular language (referred to as the presentation language). This particular language can be a language specified by the user of the search UI subsystem, can be a default language of the search UI subsystem, can be a language specified by another component or device, and so forth. The language in which the set of geographic place names is presented can be different than the language in which the user input is received. For example, a user may desire to view geographic place names in the Korean language, but provides a user input in the English language because the user does not know or can't remember the name of a particular geographic place in the Korean language. Thus, the user can enter the name of the geographic place in the English language, and select the desired geographic place name when he or she sees it displayed in the Korean language.

The presentation of the set of geographic place names in any of the languages supported by the search subsystem and search UI subsystem can readily be performed due to the translations of the various geographic place names in the geographic place name data store. As discussed above, translations of the geographic place names in the various supported languages are included in the geographic place name data store. In one or more embodiments, the search UI subsystem provides an indication of the presentation language to the search subsystem, and for each matching geographic place name in the set identified in act 310, an indication of the geographic place name in the presentation language is provided to the search UI subsystem in act 312. Alternatively, for each geographic place name in the set identified in act 310, the search subsystem can provide in act 312 an indication of the geographic place name in each of the supported languages, and the search UI subsystem can select the appropriate translation of the geographic place name given the presentation language.

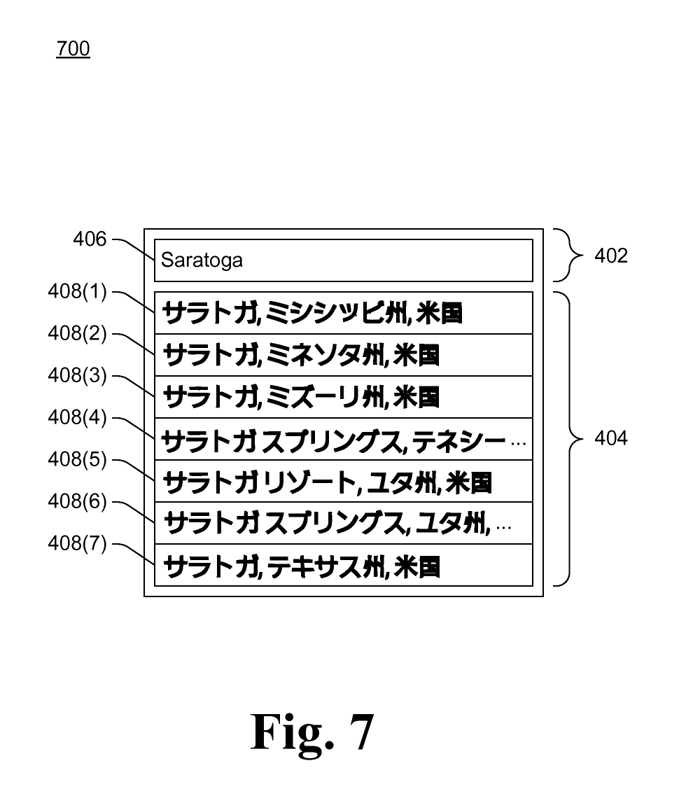

FIG. 7 illustrates an example user interface 700 implementing the facilitating searching for geographic place names discussed herein. The user interface 700 includes the data entry portion 402 with the data entry field 406, and the geographic place name display portion 404. In the illustrated example of FIG. 7, the user input is the characters “Saratoga”, which is displayed in the data entry field 406. The set of geographic place names that match the user input “Saratoga” are displayed in the geographic place name display portion 404 in fields 408(1), . . . , 408(7). The desired presentation language is the Japanese language, so seven different geographic place names that match the user input are displayed in the geographic place name display portion 404 in the Japanese language. It should be noted that although, as illustrated, the Japanese characters in the geographic place names in fields 408 themselves are not the same as the characters “Saratoga”, the translations of those geographic place names in fields 408 in different languages (e.g., English) are the same as the characters “Saratoga”. A user can select one of the displayed geographic place names in the geographic place name display portion 404 in any of a variety of different manners, as discussed above regarding FIG. 3.

Returning to FIG. 3, process 300 can be performed at various times. In one or more embodiments, process 300 is performed after each character is input by a user. Thus, the set of geographic place names presented in act 316 changes in response to each character input or change (e.g., deleting of a character, changing of a character, etc.). Alternatively, process 300 can be performed only after a threshold number of characters have been input (e.g., 2 or 3 characters). Process 300 can also optionally be performed after a pause of a threshold amount of time (e.g., 2 or 3 seconds) during the user input. Thus, if the user were to be quickly typing in characters of a geographic place name and then pause for the threshold amount of time, process 300 would be performed in response to the pause for the threshold amount of time (but would not be performed while the characters were being quickly typed in).

In one or more embodiments, the search subsystem caches an identified set of multiple geographic place names and corresponding user input. The search subsystem maintains this identified set and corresponding user input so that if the user input is received again as a subsequent user input, the cached identified set can be provided to the search UI subsystem rather than having the search subsystem repeat the accessing and identifying of acts 308 and 310. This cached identified set and corresponding user input can be stored in various different data stores (e.g., by the data search module 126 of FIG. 1).

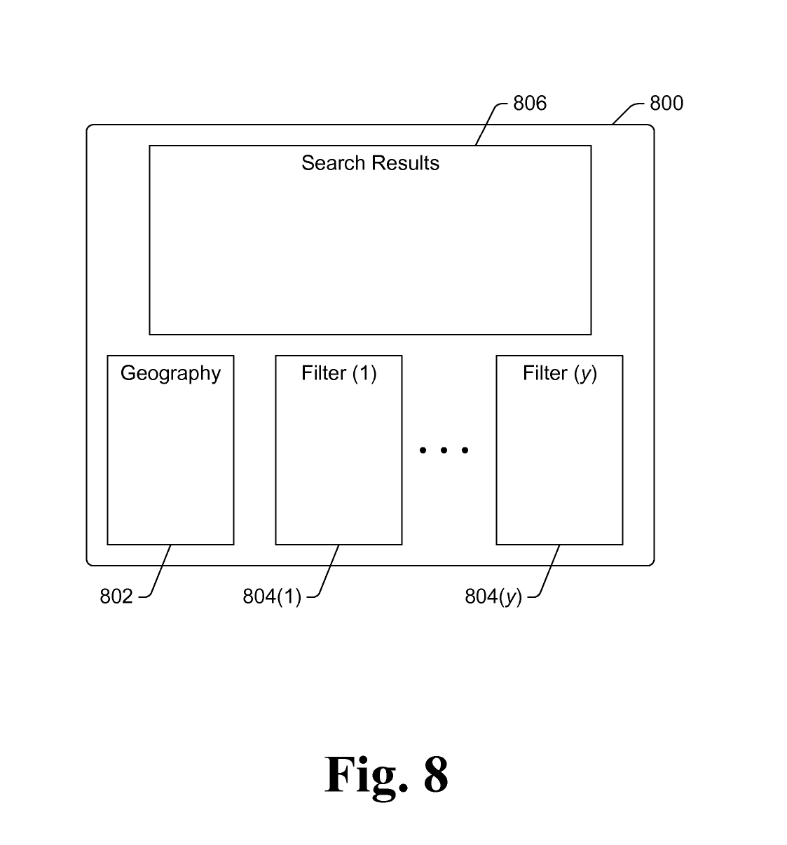

FIG. 8 illustrates an example display 800 for searching data using the facilitating searching for geographic place names discussed herein. A geographic search user interface 802 is displayed, as well as search user interfaces 804(1), . . . , 804(y) for one or more (y) additional filters. The geographic search user interface (e.g., presented by the geographic place search UI module 116 of FIG. 1) allows the user to input characters of a desired geographic place name and select a geographic place name from a set of multiple geographic place names that match the user input as discussed above. Additional search filters or criteria can be input by the user via the search user interfaces 804. Various different search filters or criteria can be input, such as type of data to be searched (e.g., type of social media to be searched, such as messages posted on walls, tweets, and so forth), a time range of data (e.g., when data was created, posted, or otherwise published), a date range of data (e.g., the days on which data was created, posted, or otherwise published), and so forth.

Search results are generated (e.g., by the data search module 126 of FIG. 1) and presented on the display 800 as search results 806. The search results 806 are the data (e.g., in the additional data store 128 of FIG. 1) that satisfy the geographic place name input by the user via geographic search user interface 802 as well as the additional filters or criteria input by the user via search user interfaces 804.

The techniques discussed herein support various usage scenarios. For example, a user desiring to select a particular geographic place name as a filter when searching for social media data can quickly and easily identify the desired geographic place name with the entry of only some of the characters in the desired geographic place name. The user need not be aware of the characters used in the desired geographic place name in any particular language—he or she can enter the characters in any language he or she desires.

Although particular functionality is discussed herein with reference to particular modules, it should be noted that the functionality of individual modules discussed herein can be separated into multiple modules, and/or at least some functionality of multiple modules can be combined into a single module.

Additionally, various actions performed by various modules are discussed herein. A particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

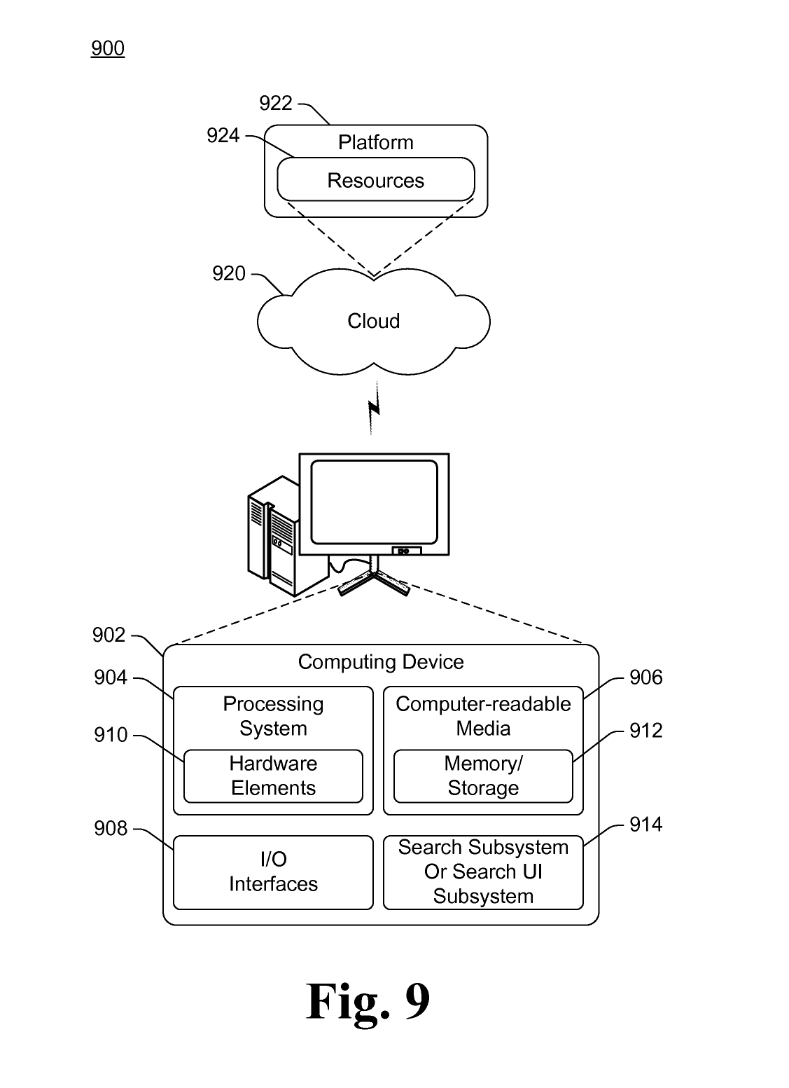

FIG. 9 illustrates an example system generally at 900 that includes an example computing device 902 that is representative of one or more computing systems and/or devices that may implement the various techniques described herein. This is illustrated through inclusion of the subsystem 914, which can be a search subsystem (e.g., search subsystem 102 of FIG. 1) or a search UI subsystem (e.g., search UI subsystem 104 of FIG. 1). Computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interfaces 908 that are communicatively coupled, one to another. Although not shown, computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

Processing system 904 is representative of functionality to perform one or more operations using hardware. Accordingly, processing system 904 is illustrated as including hardware elements 910 that may be configured as processors, functional blocks, and so forth. This may include implementation in hardware as an application specific integrated circuit or other logic device formed using one or more semiconductors. Hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

Computer-readable storage media 906 is illustrated as including memory/storage 912. Memory/storage 912 represents memory/storage capacity associated with one or more computer-readable media. Memory/storage component 912 may include volatile media (such as random access memory (RAM)) and/or nonvolatile media (such as read only memory (ROM), Flash memory, optical disks, magnetic disks, and so forth). Memory/storage component 912 may include fixed media (e.g., RAM, ROM, a fixed hard drive, and so on) as well as removable media (e.g., Flash memory, a removable hard drive, an optical disc, and so forth). Computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by computing device 902. By way of example, and not limitation, computer-readable media may include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. Computing device 902 may be configured to implement particular instructions and/or functions corresponding to the software and/or hardware modules. Accordingly, implementation of a module that is executable by computing device 902 as software may be achieved at least partially in hardware, e.g., through use of computer-readable storage media and/or hardware elements 910 of processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of computing device 902 and are not limited to the specific examples of the techniques described herein. This functionality may also be implemented all or in part through use of a distributed system, such as over a “cloud” 920 via a platform 922 as described below.

Cloud 920 includes and/or is representative of a platform 922 for resources 924. Platform 922 abstracts underlying functionality of hardware (e.g., servers) and software resources of cloud 920. Resources 924 may include applications and/or data that can be utilized while computer processing is executed on servers that are remote from computing device 902. Resources 924 can also include services provided over the Internet and/or through a subscriber network, such as a cellular or Wi-Fi network.

Platform 922 may abstract resources and functions to connect computing device 902 with other computing devices. Platform 922 may also serve to abstract scaling of resources to provide a corresponding level of scale to encountered demand for resources 924 that are implemented via platform 922. Accordingly, in an interconnected device embodiment, implementation of functionality described herein may be distributed throughout system 900. For example, the functionality may be implemented in part on computing device 902 as well as via platform 922 that abstracts the functionality of the cloud 920.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving an indication of a user input that is a subset of characters in a name of a geographic place;
accessing a data store of geographic place names of multiple different types of geographic places, the data store including geographic place names in multiple different languages for each of multiple different geographic places of each of the multiple different types of geographic places;
identifying, from the data store, a set of multiple geographic place names that match the user input; and
providing an indication of the set of multiple geographic place names for presentation to a user.

2. A method as recited in claim 1, further comprising determining that a geographic place name matches the user input in response to the geographic place name including the subset of characters in the same locations of the geographic place name as the user input.

3. A method as recited in claim 2, the set of multiple geographic place names including geographic place names for each of two or more of the multiple different types of geographic places.

4. A method as recited in claim 1, the multiple different types of geographic places including cities, countries, and regions.

5. A method as recited in claim 4, the regions comprising states.

6. A method as recited in claim 4, the multiple different types of geographic places further including region codes and country codes.

7. A method as recited in claim 1, further comprising repeating the accessing, identifying, and providing for additional user inputs as additional characters are received and included in the subset of characters.

8. A method as recited in claim 1, further comprising:
caching the set of multiple geographic place names identified for a particular user input;
subsequently receiving, after providing the indication of the set of multiple geographic place names, an additional user input that is the same as the particular user input; and
providing an indication of the cached set of multiple geographic place names rather than accessing the data store and identifying the set of multiple geographic place names from the data store.

9. A method as recited in claim 1, further comprising:
receiving an indication of a user selected one of the set of multiple geographic place names; and
using the selected geographic place name as a search filter for searching social media data.

10. A method comprising:
receiving a user input that is a subset of characters in a name of a geographic place;
obtaining a set of multiple geographic place names that match the user input, the set of multiple geographic place names being obtained from a data store of geographic place names of multiple different types of geographic places, the data store including geographic place names in multiple different languages for each of multiple different geographic places; and
displaying the set of multiple geographic place names.

11. A method as recited in claim 10, the set of multiple geographic place names including geographic place names for each of two or more of the multiple different types of geographic places.

12. A method as recited in claim 11, the multiple different types of geographic places including cities, countries, and regions.

13. A method as recited in claim 10, further comprising:
receiving a user selection of one of the displayed set of multiple geographic place names; and
providing the selected geographic place name to a search subsystem as a search filter for searching social media data.

14. A method as recited in claim 10, further comprising displaying the set of multiple geographic place names in one of the multiple different languages that is different than the language of the user input.

15. A search subsystem implemented on one or more computing devices, the search subsystem including:
a data store of geographic place names of multiple different types of geographic places, the data store including geographic place names in multiple different languages for each of multiple different geographic places of each of the multiple different types of geographic places; and
a geographic place search module configured to
receive an indication of a user input that is a subset of characters in a name of a geographic place,
identify, from the data store, a set of multiple geographic place names that match the user input, and
providing an indication of the set of multiple geographic place names for presentation to a user.

16. A search subsystem as recited in claim 15, the geographic place search module being further configured to determine that a geographic place name matches the user input in response to the geographic place name beginning with the subset of characters.

17. A search subsystem as recited in claim 15, the set of multiple geographic place names including geographic place names for each of two or more of the multiple different types of geographic places.

18. A search subsystem as recited in claim 15, the multiple different types of geographic places including cities, countries, and regions.

19. A search subsystem as recited in claim 18, the regions comprising states.

20. A search subsystem as recited in claim 19, the multiple different types of geographic places further including region codes and country codes.
